(19) United States
(12) Patent Application Publication
(10) Pub. No.: US 2019/0085633 A1
(43) Pub. Date: Mar. 21, 2019

(54) Ladder Tray Assembly

(71) Applicant: Beau Hendriex, Rockford, IL (US)

(72) Inventor: Beau Hendriex, Rockford, IL (US)

(21) Appl. No.: 15/709,599

(22) Filed: Sep. 20, 2017

(51) Int. Cl. E06C 7/14

(52) U.S. Cl. CPC E06C 7/14

(57) ABSTRACT

A ladder tray assembly for storing tools on a ladder includes a tray that may be removably coupled to a ladder. The tray has a plurality of first apertures extending therethrough to insertably receive an elongated tool for storage. The tray has a plurality of second apertures extending therethrough to insertably receive an elongated tool for storage. The tray has a plurality of wells therein to receive a container thereby inhibiting the container from sliding off of the tray. A panel is coupled to the tray and the panel frictionally engages a step on the ladder thereby retaining the tray on the ladder.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to tray devices and more particularly pertains to a new tray device for storing tools on a ladder.

### BRIEF SUMMARY OF THE INVENTION

An embodiment of the disclosure meets the needs presented above by generally comprising a tray that may be removably coupled to a ladder. The tray has a plurality of first apertures extending therethrough to insertably receive an elongated tool for storage. The tray has a plurality of second apertures extending therethrough to insertably receive an elongated tool for storage. The tray has a plurality of wells therein to receive a container thereby inhibiting the container from sliding off of the tray. A panel is coupled to the tray and the panel frictionally engages a step on the ladder thereby retaining the tray on the ladder.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a ladder tray assembly according to an embodiment of the disclosure.

FIG. 2 is a top perspective view of an embodiment of the disclosure.

FIG. 3 is a right side phantom view of an embodiment of the disclosure.

FIG. 4 is a top phantom view of an embodiment of the disclosure.

FIG. 5 is a perspective in-use view of an embodiment of the disclosure.

### DETAILED DESCRIPTION OF THE INVENTION

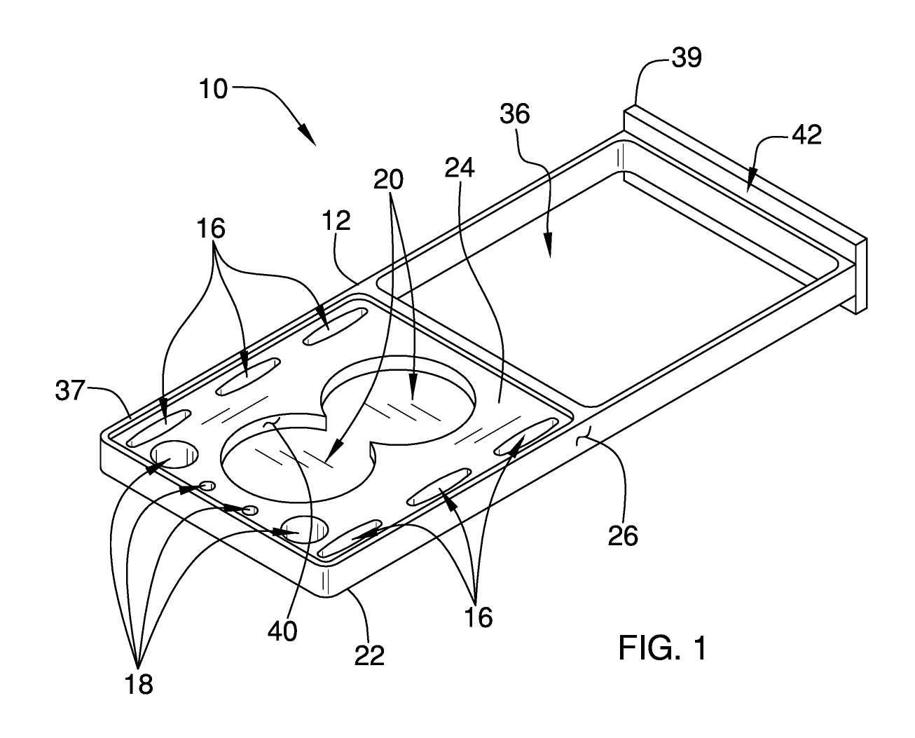

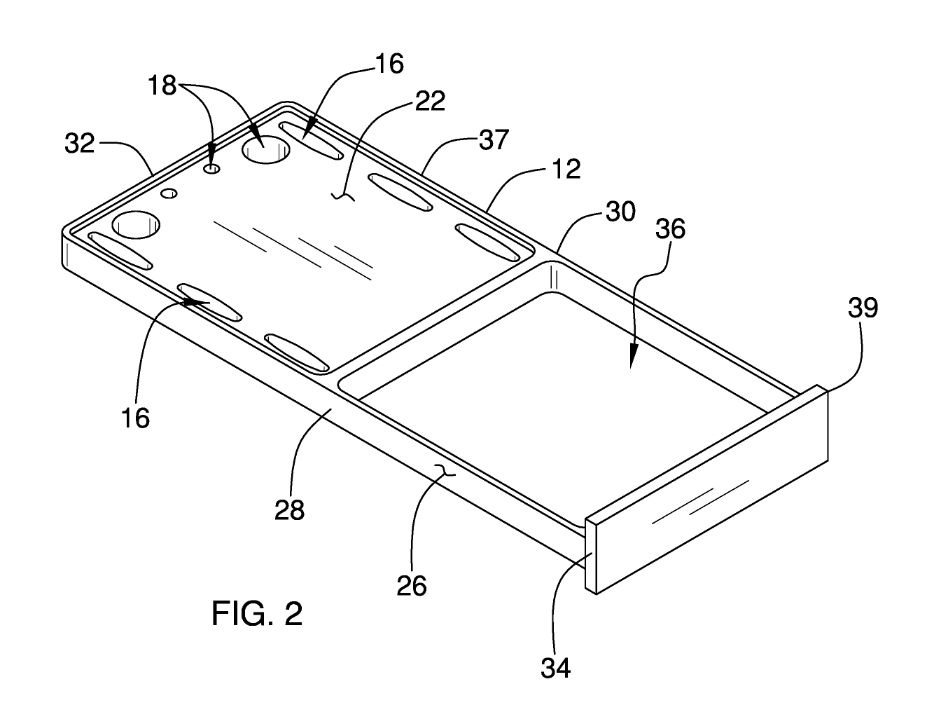

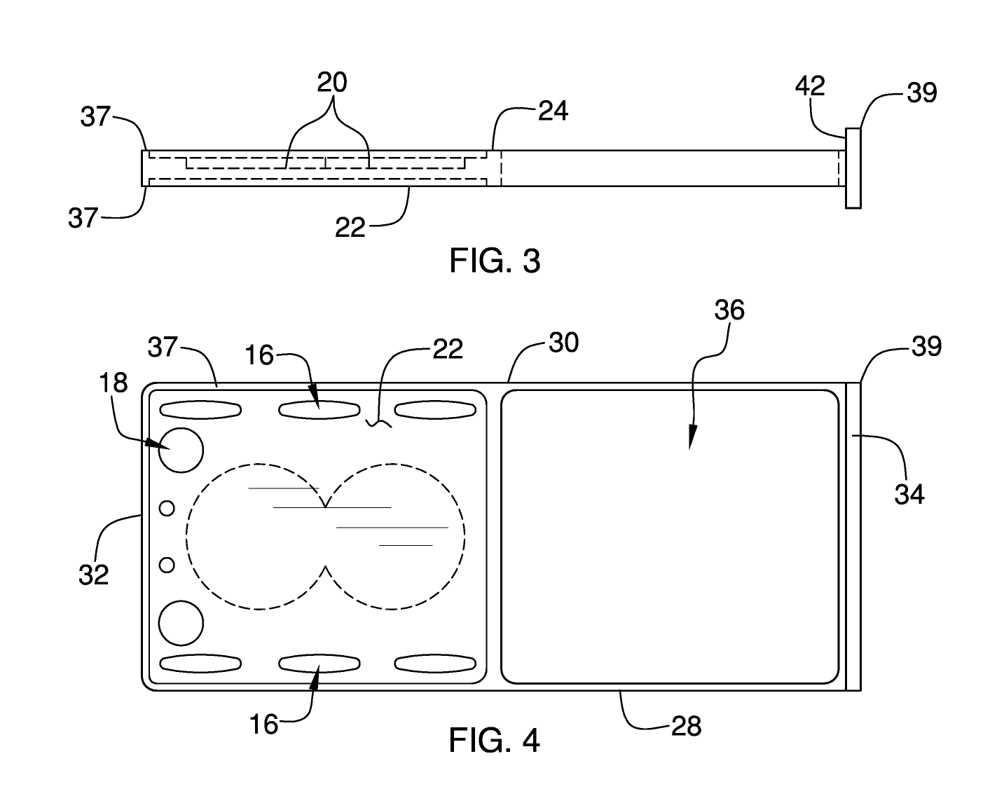

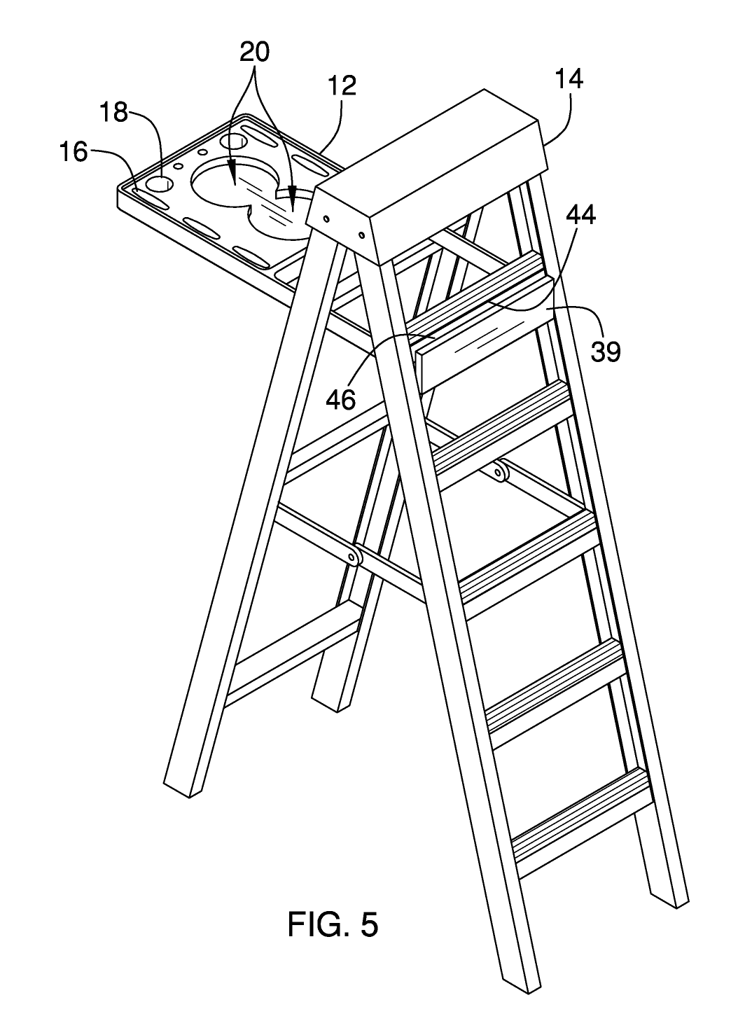

With reference now to the drawings, and in particular to FIGS. 1 through 5 thereof, a new tray device embodying the principles and concepts of an embodiment of the disclosure and generally designated by the reference numeral 10 will be described.

As best illustrated in FIGS. 1 through 5, the ladder tray assembly 10 generally comprises a tray 12 that may be removably coupled to a ladder 14. The ladder 14 may be a step 32 ladder 14 or the like that has a first half hingedly coupled to a second half. The tray 12 has a plurality of first apertures 16 extending therethrough to insertably receive an elongated tool, such as a screw driver or the like, for storage. The tray 12 has a plurality of second apertures 18 extending therethrough to insertably receive an elongated tool for storage. Additionally, the tray 12 has a plurality of wells 20 therein to receive a container thereby inhibiting the container from sliding off of the tray 12. The container may be a paint can, a bucket and any other cylindrical container.

The tray 12 has a first surface 22, a second surface 24 and a peripheral surface 26 extending therebetween. The peripheral surface 26 has a first lateral side 28, a second lateral side 30, a front side 32 and a back side 34. The tray 12 has a hole 36 extending through the first 22 and second 24 surfaces thereby reducing a weight of the tray 12. The hole 36 extends from the back side 34 toward the front side 32 to define a front half 38 of the tray 12 that is spaced from the back side 34 of the peripheral surface 26. Additionally, the peripheral surface 26 extends beyond each of the first 22 and second 24 surfaces to define a lip 37 on each of the first 22 and second 24 surfaces to inhibit the tools and objects from sliding off of the tray 12.

Each of the first apertures 16, the second apertures 18 and the wells 20 is positioned on the front half 38 of the tray 12. Each of the first apertures 16 extends through the first 22 and second 24 surfaces and each of the first apertures 16 is elongated such that each of the first apertures 16 has an ovoid shape. The first apertures 16 are spaced apart from each other and are distributed along each of the first 28 and second 30 lateral sides of the peripheral surface 26. Each of the second apertures 18 extends through the first 22 and second 24 surfaces. The second apertures 18 are spaced apart from each other and are distributed along the front side 32 of the peripheral surface 26. Moreover, each of the second apertures 18 may have a circular shape and each of the second apertures 18 may have a unique diameter with respect to each other.

Each of the wells 20 is positioned on the second surface 24 and each of the wells 20 has a bounding surface 40. The bounding surface 40 corresponding to each of the wells 20 is concavely arcuate such that each of the wells 20 has a circular shape. Moreover, each of the wells 20 is centrally positioned on the panel 39. Each of the wells 20 intersects each other such that the pair of wells 20 forms a figure eight.

A panel 39 is coupled to the tray 12 and the panel 39 frictionally engages a step 41 on the ladder 14 when the tray 12 is positioned on the ladder 14. In this way the panel 39 retains the tray 12 on the ladder 14. The panel 39 has a primary surface 42 and the primary surface 42 is coupled to the back side 34 of the peripheral surface 26 of the tray 12. The panel 39 is coextensive with the back side 34 and the panel 39 extends beyond each of the first surface 22 and the second surface 24 of the tray 12. The tray 12 extends beneath a bottom side 44 of the step 32 and the primary surface 42 of the panel 39 frictionally engages a front edge 46 of the step 41.

The tray 12 is selectively positioned in a first position having the first surface 22 of the tray 12 resting on a support on the ladder 14. The second surface 24 is directed upwardly when the tray 12 is in the first position to support tools and objects. The tray 12 is selectively positioned in a second position having the second surface 24 resting on the support on the ladder 14. The first surface 22 is directed upwardly when the tray 12 is in the second position to support tools and objects.

In use, the ladder 14 is unfolded and the tray 12 is positioned on top of selected one of the supports on the first half of the ladder 14. The tray 12 abuts the bottom side 44 of selected one of the steps 41 on the ladder 14. The panel 39 frictionally engages the front side 32 of the selected step 41 to retain the tray 12 on the ladder 14. The tray 12 facilitates the tools and objects to be accessible while standing on the ladder 14. The tray 12 is selectively positioned in the first and second positions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A ladder tray assembly being configured to be coupled to a ladder thereby facilitating tools to be positioned on said assembly, said assembly comprising:
a tray being configured to be removably coupled to a ladder, said tray having a plurality of first apertures extending therethrough wherein each of said first apertures is configured to insertably receive an elongated tool for storage, said tray having a plurality of second apertures extending therethrough wherein each of said second apertures is configured to insertably receive an elongated tool for storage, said tray having a plurality of wells therein wherein each of said wells is configured to receive a container thereby inhibiting the container from sliding off of said tray, said tray having a first surface, a second surface and a peripheral surface extending therebetween, said peripheral surface having a first lateral side, a side second lateral side, a front side and a back side, said tray having a hole extending through said first and second surfaces thereby reducing a weight of said tray, said hole extending from said back side toward said front side to define a front half of said tray being spaced from said back side of said peripheral surface, each of said first apertures, said second apertures and said wells are positioned on said front half of said tray, each of said first apertures extending through said first and second surfaces, each of said first apertures being elongated such that each of said first apertures has an ovoid shape, said first apertures being spaced apart from each other and being distributed along each of said first and second lateral sides of said peripheral surface; and
a panel being coupled to said tray wherein said panel is configured to frictionally engage a step on the ladder thereby retaining said tray on the ladder.

2. (canceled)

3. (canceled)

4. The assembly according to claim 1, wherein each of said second apertures extends through said first and second surfaces, said second apertures being spaced apart from each other and being distributed along said front side of said peripheral surface.

5. The assembly according to claim 1, wherein each of said wells is positioned on said second surface, each of said wells having a bounding surface, said bounding surface corresponding to each of said wells being concavely arcuate such that each of said wells has a circular shape.

6. The assembly according to claim 5, wherein each of said wells is centrally positioned on said panel, each of said wells intersecting each other such that said pair of wells forms of figure eight.

7. The assembly according to claim 1, wherein said panel has a primary surface, said primary surface being coupled to said back side of said peripheral surface of said tray having said panel being coextensive with said back side, said panel extending beyond each of said first surface and said second surface of said tray wherein said primary surface of said panel is configured to frictionally engage the step.

8. The assembly according to claim 7, wherein said tray is selectively positioned in a first position having said first surface of said tray resting on a support on the ladder having said second surface being directed upwardly wherein said second surface is configured to support tools and objects.

9. The assembly according to claim 7, wherein said tray is selectively positioned in a second position having said second surface resting on the support on the ladder having said first surface being directed upwardly wherein said first surface is configured to support tools and objects.

10. A ladder tray assembly being configured to be coupled to a ladder thereby facilitating tools to be positioned on said assembly, said assembly comprising:
a tray being configured to be removably coupled to a ladder, said tray having a plurality of first apertures extending therethrough wherein each of said first apertures is configured to insertably receive an elongated tool for storage, said tray having a plurality of second apertures extending therethrough wherein each of said second apertures is configured to insertably receive an elongated tool for storage, said tray having a plurality of wells therein wherein each of said wells is configured to receive a container thereby inhibiting the container from sliding off of said tray, said tray having a first surface the second surface and a peripheral surface extending therebetween, said peripheral surface having a first lateral side, a side second lateral side, a front side and a back side, said tray having a hole extending through said first and second surfaces thereby reducing a weight of said tray, said hole extending from said back side toward said front side to define a front half of said tray being spaced from said back side of said peripheral surface, each of said first apertures, said second apertures and said wells being positioned on said front half of said tray, each of said first apertures extending through said first and second surfaces, each of said first apertures being elongated such that each of said first apertures has an ovoid shape, said first apertures being spaced apart from each other and being distributed along each of said first and second lateral sides of said peripheral surface, each of said second apertures extending through said first and second surfaces, said second apertures being spaced apart from each other and being distributed along said front side of said peripheral surface, each of said wells being positioned on said second surface, each of said wells having a bounding surface, said bounding surface corresponding to each of said wells being concave the arcuate such that each of said wells has a circular shape, each of said wells being centrally positioned on said panel, each of said wells intersecting each other such that said pair of wells forms of figure eight; and
a panel being coupled to said tray wherein said panel is configured to frictionally engage a step on the ladder thereby retaining said tray on the ladder said panel having a primary surface, said primary surface being coupled to said back side of said peripheral surface of said tray having said panel being coextensive with said back side, said panel extending beyond each of said first surface and said second surface of said tray wherein said primary surface of said panel is configured to frictionally engage the step, said tray being selectively positioned in a first position having said first surface of said tray resting on a support on the ladder having said second surface being directed upwardly wherein said second surface is configured to support tools and objects, said tray being selectively positioned in a second position wherein said tray is selectively positioned in a second position having said second surface resting on the support on the ladder having said first surface being directed upwardly wherein said first surface is configured to support tools and objects.
